(19) United States
(12) Patent Application Publication
(10) Pub. No.: US 2026/0303210 A1
(43) Pub. Date: Oct. 1, 2026

(54) ELECTRONIC APPARATUS, OPTICAL COMMUNICATION PERFORMANCE VERIFICATION METHOD THEREOF, AND NON-TRANSITORY COMPUTER-READABLE RECORDING MEDIUM COMPRISING A COMPUTER PROGRAM FOR PERFORMING THE METHOD

(71) Applicant: AGENCY FOR DEFENSE DEVELOPMENT, Daejeon (KR)

(72) Inventors: Hyeok Gyu CHOI, Daejeon (KR); Seung Ho KIM, Daejeon (KR); Joo Hee HAN, Daejeon (KR)

(21) Appl. No.: 19/633,056

(22) Filed: Mar. 30, 2026

(30) Foreign Application Priority Data
Apr. 1, 2025 (KR) 10-2025-0042239

(51) Int. Cl. H04B 10/079; H04B 10/50

(52) U.S. Cl. CPC H04B 10/0795; H04B 10/503

(57) ABSTRACT

According to the present disclosure, there is provided an optical communication performance verification method performed by an electronic device, the optical communication performance verification method including generating at least one laser using at least one laser generation device, converting the at least one laser into at least one optical signal using an optical modulator, and amplifying the at least one optical signal using a first amplifier, identifying a designated optical signal separated using a diplexer from the amplified at least one optical signal, and converting the designated optical signal into a designated electrical signal using an optical modem and verifying the optical communication performance of the electronic device based on the designated electrical signal.

### PRIORITY INFORMATION

This application claims the benefit of Korean Patent Application No. 10-2025-0042239, filed on Apr. 1, 2025, in the Korean Intellectual Property Office, the disclosure of which is incorporated herein by reference in its entirety.

### FIELD OF THE INVENTION

Example embodiments relate to an electronic device, an optical communication performance verification method thereof, and a non-transitory computer-readable storage medium having a computer program for performing the method, and more particularly, to an electronic device that converts a laser generated using a laser generation device into an optical signal and self-verifies its optical communication performance using at least a portion of the converted optical signal, an optical communication performance verification method thereof, and a non-transitory computer-readable storage medium having a computer program for performing the method recorded thereon.

### DISCUSSION OF THE RELATED ART

Optical communication is a technology that transmits data using light, utilized in various fields such as data centers, communication networks, 5G networks, and satellite communications. Verifying the performance of electronic devices that perform this optical communication is a critical process, which is essentially performed for ensuring reliability and quality assurance.

Optical communication systems demand high transmission speeds and low latency while minimizing data loss and signal distortion. Therefore, a process to verify that electronic devices meet the required performance specifications is necessary.

For example, verifying optical communication performance may require assessing the quality of optical signals (e.g., BER, Q-factor, Eye Diagram analysis), measuring transmission distance and attenuation, or conducting various impact analyses considering temperature and environmental factors.

Electronic devices performing optical communication can transmit and receive data through free space, such as air, vacuum, or outer space. These electronic devices can communicate based on rapid data transmission speeds using laser beams across relatively high bandwidths and enable long-distance communication with relatively narrow beam widths.

Meanwhile, optical communication can generally be performed between the first electronic device at the transmitting end and the second electronic device at the receiving end. Therefore, continuous verification and monitoring of optical communication performance is necessary for its smooth operation without any issues. However, due to the fundamental characteristics of optical communication described above, testing and verification of optical communication performance is limited within a single electronic device, necessitating verification through at least two electronic devices. Furthermore, since electronic devices for optical communication are implemented for communication over relatively long distances (e.g., thousands of kilometers), there was a limitation requiring separate devices such as attenuators or beam expanders to implement communication between electronic devices for verification at close range.

### SUMMARY

An aspect provides an electronic device that verifies optical communication performance by processing at least a portion of the optical signals generated by an electronic device through a receiver, thereby enabling rapid and efficient self-diagnosis of component issues for optical communication without external influence or additional equipment., an optical communication performance verification method thereof, and a non-transitory computer-readable storage medium having a computer program for performing the method recorded thereon.

The technical aspects of the present disclosure are not limited to those mentioned above, and other technical aspects can be inferred from the following example embodiments.

According to an aspect, there is provided an optical communication performance verification method performed by an electronic device, including generating at least one laser using at least one laser generation device, converting the at least one laser into at least one optical signal using an optical modulator, and amplifying the at least one optical signal using a first amplifier, identifying a designated optical signal separated using a diplexer from the amplified at least one optical signal, and converting the designated optical signal into a designated electrical signal using an optical modem and verifying optical communication performance of the electronic device based on the designated electrical signal.

According to an example embodiment, the at least one laser generation device may include a wavelength-tunable distributed Bragg reflector (DBR) or integrable tunable laser assembly (ITLA). For example, the optical communication performance verification method may further include generating a first laser and a second laser having mutually different wavelength bands using the at least one laser generation device.

According to an example embodiment, the at least one laser generation device may include a first laser generation device generating a first laser of a first wavelength band and a second laser generation device generating a second laser of a second wavelength band different from the first wavelength band. For example, the optical communication performance verification method may further include generating the first laser and the second laser, converting the first laser and the second laser into a first optical signal and a second optical signal, respectively, using the optical modulator, and amplifying the first optical signal and the second optical signal using the first amplifier, and identifying the first optical signal and second optical signal separated using the diplexer.

According to an example embodiment, the diplexer may be configured to separate the first optical signal and the second optical signal based on optical characteristics including wavelengths or frequencies of the first optical signal and the second optical signal.

According to an example embodiment, the optical communication performance verification method may further include radiating the first optical signal reflected by the diplexer into free space using a telescope, and converting the second optical signal transmitted by the diplexer into the designated electrical signal using the optical modem and verifying the optical communication performance of the electronic device based on the designated electrical signal.

According to an example embodiment, the second optical signal passes through the diplexer, is reflected by a retro-reflector toward a rear surface of the diplexer, and is reflected again by the rear surface of the diplexer and enters a beam splitter, and at least a portion of the second optical signal is transmitted from the beam splitter to a sensor or a second collimator. The optical communication performance verification method may further include acquiring at least a portion of the second optical signal using the sensor, and converting the second optical signal into the designated electrical signal using the optical modem, and verifying the optical communication performance of the electronic device based on the designated electrical signal or the at least a portion of the second optical signal.

According to an example embodiment, the diplexer may include a first coating layer configured to transmit an optical signal of a designated wavelength band among a plurality of wavelength bands toward the retro-reflector and to reflect an optical signal outside the designated wavelength band toward the telescope, and a second coating layer configured to reflect an optical signal of the designated wavelength band among the plurality of wavelength bands toward the optical modem.

According to an example embodiment, the optical communication performance verification method may further include identifying the designated optical signal separated using the diplexer from the at least one optical signal processed using a first collimator, post-processing the designated optical signal processed through a second collimator via a second amplifier and an optical filter, and converting the post-processed designated optical signal into the designated electrical signal using the optical modem.

According to an example embodiment, the optical communication performance verification method may further include controlling opening and closing of a first switch so that a first loopback signal among the at least one optical signal converted through the optical modulator is directly transmitted to the optical modem, or controlling opening and closing of a second switch so that a second loopback signal among the at least one optical signal amplified by the first amplifier is delivered to the optical modem after being post-processed through a second amplifier and an optical filter, and converting at least a portion of the first loopback signal and the second loopback signal into the designated electrical signal using the optical modem. For example, the first switch may be positioned downstream of the optical modulator, and the second switch may be positioned downstream of the first amplifier.

According to an example embodiment, the first loopback signal may be attenuated through a first variable optical attenuator and transmitted to the optical modem via the optical filter, and the second loopback signal may be attenuated through a second variable optical attenuator and transmitted to the optical modem via the second amplifier and the optical filter.

According to another aspect, there is also provided a non-transitory computer-readable recording medium having a program for executing an optical communication performance verification method on a computer recorded thereon, the optical communication performance verification method including generating at least one laser using at least one laser generation device, converting the at least one laser into at least one optical signal using an optical modulator, and amplifying the at least one optical signal using a first amplifier, identifying a designated optical signal separated using a diplexer from the amplified at least one optical signal, and converting the designated optical signal into a designated electrical signal using an optical modem and verifying the optical communication performance of an electronic device performing optical communication based on the designated electrical signal.

According to yet another aspect, there is also provided an electronic device including a memory storing at least one instruction, and a processor operatively coupled to the memory. For example, the at least one instruction may cause, when executed by the processor, the electronic device to generate at least one laser using at least one laser generation device, convert the at least one laser into at least one optical signal using an optical modulator, and amplify the at least one optical signal using a first amplifier, identify a designated optical signal separated using a diplexer from the amplified at least one optical signal, and convert the designated optical signal into a designated electrical signal using an optical modem and verify the optical communication performance of the electronic device based on the designated electrical signal.

The various example embodiments described above represent only some example embodiments of the present disclosure. Various other example embodiments incorporating the technical features of the various example embodiments described herein may be derived and understood by those skilled in the art based on the detailed description provided below.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a block diagram illustrating components of an electronic device performing an optical communication performance verification method according to an example embodiment;

FIG. 2A is a block diagram illustrating components of an electronic device performing an optical communication performance verification method according to an example embodiment;

FIG. 2B is a block diagram illustrating components of an electronic device performing an optical communication performance verification method according to an example embodiment;

FIG. 2C is a block diagram illustrating components of an electronic device performing an optical communication performance verification method according to an example embodiment;

FIG. 3 is a flowchart illustrating a method for verifying optical communication performance by an electronic device according to an example embodiment;

FIG. 4 is a flowchart illustrating a method for verifying optical communication performance by an electronic device according to an example embodiment; and

FIG. 5 is a flowchart illustrating a method for verifying optical communication performance by an electronic device according to an example embodiment.

### DETAILED DESCRIPTION

The terms used in example embodiments have been selected as general terms that are currently widely used as possible while taking functions in the present disclosure into consideration, but these may vary according to the intention of those skilled in the art, a precedent, the emergence of new technologies, and the like. In addition, in certain cases, there are terms arbitrarily selected by the applicant, and in this case, the meaning will be described in detail in the corresponding description. Therefore, the terms used in the present disclosure should be defined based on the meaning of the term and the whole contents of the present disclosure, not just the name of the term.

Throughout the specification, when it is stated that a part “comprises” or “includes” a certain component, it means that other components may further be included, and it does not preclude other components, unless otherwise stated. Furthermore, the terms such as “. . . part” and “. . . module” used in the specification refer to a unit that handles at least one function or operation, which may be implemented in hardware, software, or a combination of hardware and software.

The expression “at least one of A, B, and C” may indicate the following meaning including: A alone; B alone; C alone; both A and B together; both A and C together; both B and C together; or all three of A, B, and C together.

The “terminal” mentioned herein may be implemented as a computer or a portable terminal that may access a server or other terminal through a network. Here, the computer includes, for example, a notebook, a desktop, a laptop, and the like, equipped with a web browser, and the portable terminal is, for example, a wireless communication device that guarantees portability and mobility, which may include all kinds of handheld-based wireless communication device including communication-based terminals such as IMT (International Mobile Telecommunication), CDMA (Code Division Multiple Access), W-CDMA (W-Code Division Multiple Access), LTE (Long Term Evolution), smartphones, tablet PCs, and the like.

In the following, with reference to the accompanying drawings, example embodiments of the present disclosure will be described in detail so that those of skilled in the art to which the present disclosure pertains may easily implement them. However, the present disclosure may be implemented in various different forms and is not limited to the example embodiments described herein.

Hereinafter, example embodiments of the present disclosure will be described in detail with reference to the drawings.

In describing example embodiments, technical details that are well known in the art to which the present disclosure pertains and are not directly related to the present disclosure are omitted. This is to avoid obscuring the essence of the present disclosure and to convey it more clearly by omitting unnecessary explanations.

For the same reason, some components in the accompanying drawings are exaggerated, omitted, or shown schematically. Furthermore, the size of each component does not necessarily reflect its actual size. Identical or corresponding components in each drawing are assigned the same reference numerals.

The advantages and features of the present disclosure, and the methods for achieving them, will become clear upon reference to the detailed description of example embodiments provided below, together with the accompanying drawings. However, the present disclosure is not limited to example embodiments disclosed herein, but may be implemented in various different forms. These example embodiments are provided merely to make the disclosure complete and to fully inform those skilled in the art to which the present disclosure pertains of the scope of the disclosure. The scope of the present disclosure is defined solely by the scope of the claims. Throughout the specification, the same reference numerals refer to the same components.

At this point, it can be understood that each block in the processing flowchart drawings and the combinations of the flowchart drawings can be executed by computer program instructions. These computer program instructions can be loaded onto the processor of a general-purpose computer, a special-purpose computer, or other programmable data processing device. Thus, the instructions executed by the processor of a computer or other programmable data processing device provide a means for performing the functions described in the flowchart block(s). These computer program instructions may also be stored in computer-accessible or computer-readable memory that can direct a computer or other programmable data processing device to implement a function in a particular manner, so that the instructions stored in the computer-accessible or computer-readable memory can also produce a manufactured article that includes instruction means for performing the function described in the flowchart block(s). Since computer program instructions can also be loaded onto a computer or other programmable data processing device, a series of operational steps can be performed on the computer or other programmable data processing device to create a computer-executable process, so that the instructions executed on a computer or other programmable data processing device can also provide steps for executing the functions described in the flowchart block(s).

Furthermore, each block may represent a module, segment, or portion of code including one or more executable instructions for performing specified logical function(s). It should also be noted that in some alternative execution examples, the functions mentioned in the blocks may occur out of sequence. For example, two blocks shown consecutively may in fact be performed substantially simultaneously, or those blocks may sometimes be performed in reverse order depending on the corresponding function.

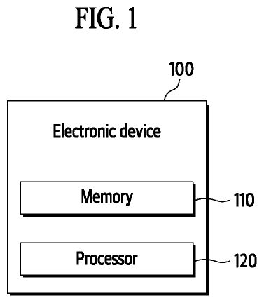

FIG. 1 is a block diagram illustrating components of an electronic device performing an optical communication performance verification method according to an example embodiment.

According to various example embodiments, a system for verifying optical communication performance includes an electronic device 100. The system for verifying optical communication performance according to an example embodiment may further include a network supporting information transmission and reception between the electronic device 100 and at least one external device (e.g., at least one server).

The electronic device 100 according to example embodiments of the present disclosure may verify optical communication performance, for example, through example embodiments described below. Furthermore, by transmitting at least a portion of the optical signal for transmission to a receiving end and performing tests and verifications, it may confirm whether the electronic device 100 is operating normally.

According to an example embodiment, the electronic device 100 may include a plurality of computer systems or computer software implemented as network servers. For example, the electronic device 100 may refer to a computer system and computer software connected to a sub-device capable of communicating with other network servers via a computer network such as an intranet or internet, receiving task execution requests, performing the corresponding tasks, and providing the execution results. Furthermore, the electronic device 100 may be understood in a broad sense as including a series of applications operable on a network server and various databases established internally or on other connected nodes. For example, the electronic device 100 may be implemented using network server programs provided in various forms depending on the operating system, such as DOS, Windows, Linux, UNIX, or macOS.

Meanwhile, for the sake of convenience in explanation, each operational entity has been referred to as a processor 120. However, this should be understood as a comprehensive form of device that may correspond to, include, or be included within various types of devices, such as computer devices and mobile communication terminals.

The electronic device 100 may be implemented as various types of hardware that perform a free-space optical communication (FSO) algorithm, which transmits information using light sources such as lasers or LEDs in a space lacking a physical medium (e.g., optical fiber), such as air or vacuum. The electronic device 100 may comprehensively perform various types of algorithms for performing optical communication (e.g., beam pointing (or alignment), navigation, tracking (PAT; pointing-acquisition-tracking) algorithms, communication signal processing algorithms such as modulation/encoding and error correction, atmospheric distortion compensation, and link maintenance algorithms), and may include components for this purpose (e.g., a sensor 285 for beam pointing, navigation, and tracking algorithms).

The electronic device 100 may perform high-speed signal processing, modulation and demodulation, error correction (FEC), and equalization (or channel compensation) algorithms in real time based on an FPGA and/or a DSP.

The electronic device 100 may utilize the processor 120 (or a microcontroller (MCU)) to execute logic control algorithms such as beam steering commands, sensor data collection, status monitoring, protocol control, and error handling.

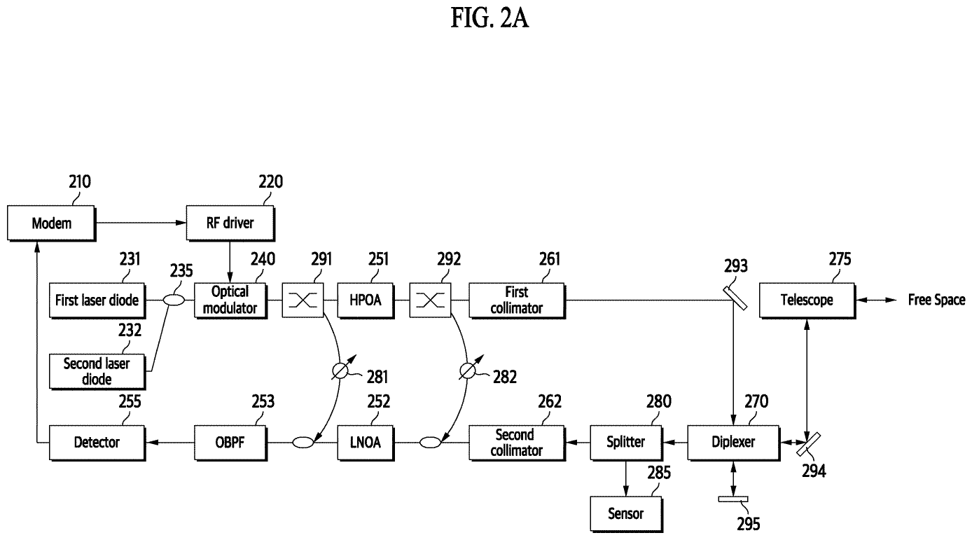

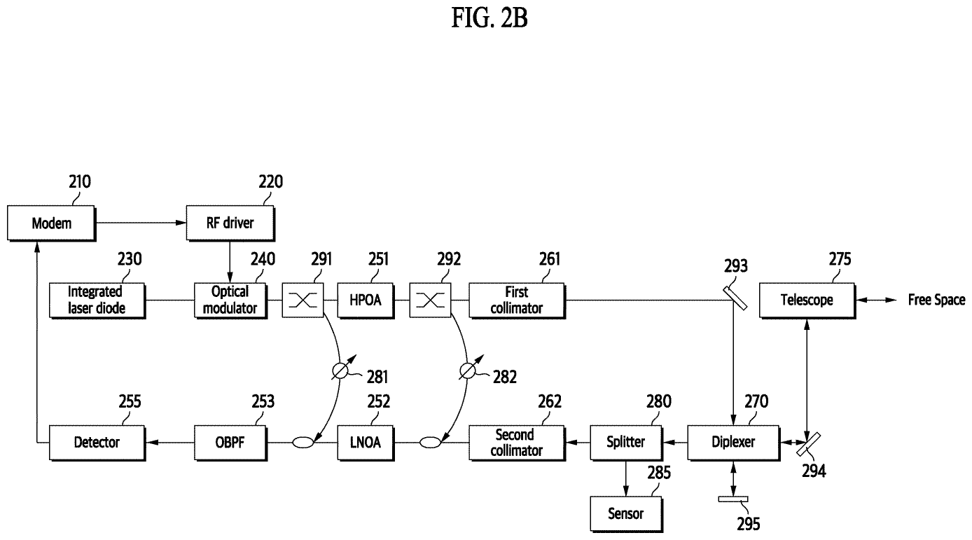

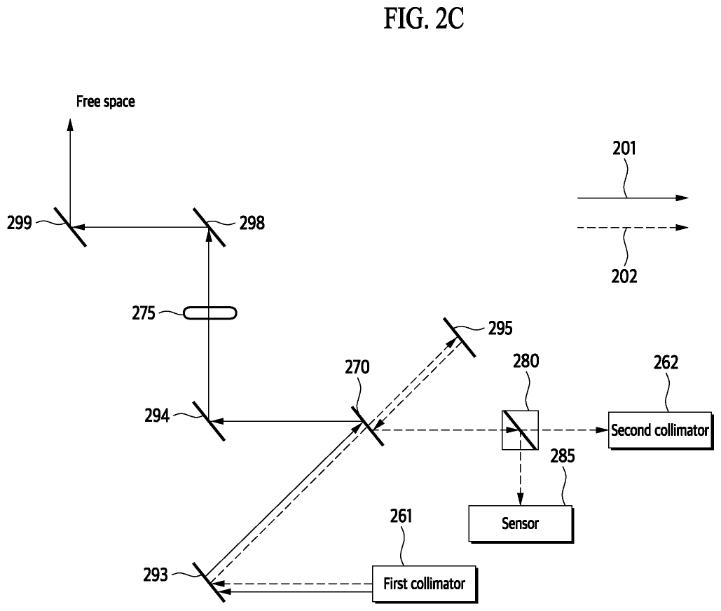

The components of the electronic device 100 shown in FIG. 1 are exemplary, and example embodiments of the present disclosure are not limited thereto. For example, the electronic device 100 may further include at least some of the components shown in FIGS. 2A and 2B, and may perform optical communication or verify optical communication performance based on at least some of the components under the control of the processor 120.

According to an example embodiment, the electronic device 100 may include a memory 110 and the processor 120. For example, the components of the electronic device 100 shown in FIG. 1 are exemplary, and example embodiments of the present disclosure are not limited thereto. For example, the electronic device 100 may further include components not shown in FIG. 1 (e.g., a communication part, an output part, a sensor part, an interface, etc.).

According to an example embodiment, the memory 110 may store instructions or data. For example, the memory 110 may store one or more instructions that, when executed by the processor 120, cause the electronic device 100 to perform various operations.

For example, the memory 110 may be implemented as a single chipset with the processor 120. The processor 120 may include at least one of a communication processor or a modem.

For example, the memory 110 may store various information associated with the electronic device 100. For instance, the memory 110 may store information regarding the operational history of the processor 120.

For example, the memory 110 may include multiple storage devices of different types. For example, the memory 110 may include volatile and/or non-volatile storage media. For example, the memory 110 may include at least one of random-access memory (RAM), read-only memory (ROM), embedded multi-media card (eMMC), or any combination thereof.

The operations of the method or algorithm described in connection with example embodiments disclosed herein may be implemented directly by hardware, software modules, or a combination of both, executed by the processor 120. Software modules may reside in storage media (i.e., the memory 110), such as RAM memory, flash memory, ROM memory, EPROM memory, EEPROM memory, registers, hard disks, removable disks, and CD-ROMs.

For example, the memory 110 may be coupled to the processor 120, which processor 120 may read information from the storage medium and write information to the storage medium. Alternatively, the memory 110 may be integrated with the processor 120. The memory 110 and processor 120 may reside within an application-specific integrated circuit (ASIC). The ASIC may reside within a user terminal. Alternatively, the memory 110 and processor 120 may reside within the user terminal as separate components.

According to an example embodiment, the processor 120 may be operatively coupled to the memory 110. For example, the processor 120 may control the operation of the memory 110. The processor 120 may include a main processor or controller (e.g., FPGA, DSP, MCU, embedded CPU, etc.) for performing optical communication algorithms.

According to an example embodiment, the processor 120 may generate at least one laser using at least one laser generation device.

For example, the at least one laser generation device may be a single laser generation device (or laser diode) that generates lasers in different wavelength bands. For instance, the at least one laser generation device may include a wavelength-tunable distributed Bragg reflector (DBR) or integrable tunable laser assembly (ITLA), capable of generating a first laser and a second laser with different wavelength bands for transmission to an optical modulator.

As another example, the at least one laser generation device may be implemented to include multiple laser generation devices generating at least one laser (e.g., a first laser and a second laser) with different wavelength bands (e.g., a first wavelength band and a second wavelength band).

For example, a coupler may be placed downstream of the at least one laser generation device. The coupler (e.g., a wavelength division multiplexing (WDM) coupler) may, for instance, combine lasers (or beams) generated by different laser generation devices into a single optical path, combine lasers of different wavelengths into a single optical fiber, split a single light source into multiple paths, output only lasers of a specific wavelength, selectively extract signals from specific diodes and transmit them to specific paths, uniformly adjust lasers from diodes with different output intensities, or perform operations to minimize distortion and/or interference between signals.

According to an example embodiment, the processor 120 may convert at least one laser into at least one optical signal using an optical modulator, and then amplify the at least one optical signal using a first amplifier.

For example, the processor 120 may convert the at least one laser into the at least one optical signal using the optical modulator. The converted at least one optical signal may be transmitted to the first amplifier (e.g., a high power optical amplifier (HPOA)) for amplification.

According to an example embodiment, the processor 120 may identify a designated optical signal separated from the amplified at least one optical signal using a diplexer.

For example, the diplexer (e.g., diplexer 270 in FIGS. 2A and 2B) may be configured to separate the first optical signal and the second optical signal based on optical characteristics including the wavelengths or frequencies of the first optical signal and the second optical signal. The diplexer may separate optical signals of different wavelengths based on, for example, arrayed waveguide grating (AWG), fiber Bragg grating (FBG), or thin-film filter (TFF). The diplexer may separate optical signals of different frequencies based on, for example, Fourier transform-based filtering or Fabry-Perot interferometer (FPI). The diplexer may separate each signal by extracting principal components from multiple optical signals based on, for example, principal component analysis (PCA).

In this disclosure, the diplexer is described as a configuration distinct from a beam splitter. However, this is merely illustrative, and example embodiments of this disclosure are not limited thereto. For example, the diplexer may be a filter (e.g., a dichroic filter) formed on the surface of the beam splitter via a multilayer thin film coating. In this case, the diplexer may be defined as a component included within the beam splitter. That is, the diplexer may be implemented as a component of the beam splitter, which is multiple layers of multilayer thin film coatings formed on the surface of the beam splitter, and the beam splitter may selectively reflect or transmit light based on light characteristics (e.g., wavelength and/or frequency) through the multilayer thin film coatings.

According to an example embodiment, the processor 120 may use an optical modem to convert a designated optical signal into a designated electrical signal and verify the optical communication performance of the electronic device 100 based on the designated electrical signal.

For example, the processor 120 may identify an optical signal for reception (e.g., the second optical signal) received via a detector (e.g., detector 255 in FIGS. 2A and 2B) from among the optical signals separated using the diplexer, then convert the optical signal for reception into an electrical signal using an optical modem (e.g., modem 210 in FIGS. 2A and 2B) and verify the optical communication performance based on the converted electrical signal.

For example, the processor 120 may convert the optical signal into the electrical signal using a photodiode and/or an avalanche photo diode (APD) included in the optical modem.

For example, the processor 120 may amplify or filter the converted electrical signal using a low-noise amplifier and an RF driver (e.g., the RF driver in FIGS. 2A and 2B). For instance, the processor 120 may amplify the optical modulator input signal at the transmitting end using the RF driver. The RF driver is electrically connected to the optical modulator. When an optical signal (or laser) is input to the optical modulator via a laser diode, the processor 120 may input an electrical signal to the optical modulator using the RF driver. The optical signal input to the optical modulator may be modulated (or amplified) based on the electrical signal input via the RF driver.

For example, the processor 120 may verify optical communication performance by itself through the signal-to-noise ratio (SNR), bit error rate (BER), modulation signal analysis (eye diagram), phase noise, frequency response analysis, etc. of the designated electrical signal.

For example, at least some of the aforementioned components (e.g., the modem 210, RF driver 220, and detector 255 (or receiver) in FIGS. 2A and 2B) may be implemented integrated with the processor 120. That is, the processor 120 may be implemented to include at least some of the optical modem, detector, low-noise amplifier, and RF driver, and the operation of the included components may be defined as operations controlled or performed by the processor 120.

According to an example embodiment, the processor 120 may radiate at least a portion of the optical signal corresponding to the at least one laser into free space.

For example, the processor 120 may use a telescope (e.g., telescope 275 in FIGS. 2A and 2B) to radiate at least a portion of the optical signal into free space. For example, the processor 120 may radiate the first optical signal, which is reflected by the diplexer and not transmitted to the detector, into free space.

For example, the processor 120 may use an optical modem to convert the second optical signal, which is transmitted by the diplexer towards the detector, into a designated electrical signal. That is, by separating the optical signals using the diplexer, the processor 120 may radiate some of the multiple optical signals into free space and convert some of the remaining signals into the designated electrical signal by identifying through the detector and processing via the modem to verify the optical communication performance. Through this, the electronic device 100 may verify the optical communication performance by itself.

According to an example embodiment, the electronic device 100 may detect at least a portion of the second optical signal transmitted through the diplexer via the detector.

For example, the processor 120 may detect the second optical signal separated by the diplexer from the at least one optical signal. The processor 120 may detect the second optical signal transmitted to the retro-reflector (e.g., the retro-reflector 295 in FIGS. 2A, 2B, and 2C) by the diplexer, incident onto the rear surface of the diplexer by the retro-reflector, and then reflected back by the rear surface of the diplexer and delivered to the beam splitter.

For example, the processor 120 may acquire (or detect) at least a portion of the second optical signal using a sensor positioned in an area adjacent to a beam splitter. The processor 120 may also use the at least a portion of the detected second optical signal to identify real-time operational history and verify optical communication performance. For instance, the processor 120 may use the sensor to verify the alignment state of an optical signal (or laser) received from an external device. The processor 120 may calculate the center position of the optical signal using the sensor. If it detects an error in the alignment state based on the calculation result, it may drive an actuator based on the error to fine-tune the direction of the receiver.

For example, the processor 120 may convert the designated optical signal (e.g., the second optical signal) into the designated electrical signal using the optical modem, and then verify the optical communication performance of the electronic device 100 based on at least a portion of the designated optical signal acquired (or detected) using the sensor or the designated electrical signal.

For example, the diplexer may include front and rear surfaces each having different coating layers. When the diplexer is implemented as coating layers, it may be placed on one surface of a beam splitter. The diplexer may transmit or reflect optical signals of specific wavelength bands through mutually different coating layers. For example, the coating layer may include a thin-film filter (TFF).

For example, the diplexer may include a first coating layer configured to transmit an optical signal of a designated wavelength band among a plurality of wavelength bands toward the retro-reflector, and to reflect an optical signal outside the designated wavelength band toward the telescope. For example, the first coating layer may be disposed on the front surface of the diplexer. That is, the diplexer may transmit, through the first coating layer, the optical signal having a wavelength included within the designated wavelength band toward the retro-reflector among the plurality of optical signals having different wavelength bands incident toward the front surface. Furthermore, the diplexer may reflect the optical signals having wavelengths outside the designated wavelength band toward the telescope, allowing those optical signals to be radiated into free space through the telescope.

For example, the diplexer may include a second coating layer configured to reflect an optical signal of the designated wavelength band among the plurality of wavelength bands toward the optical modem. For example, the retro-reflector may reflect the optical signal transmitted through the first coating layer of the diplexer back toward the rear surface of the diplexer. The optical signal incident on the rear surface of the diplexer via the retro-reflector may be reflected toward the optical modem (or beam splitter) by the second coating layer of the diplexer. Through this, the optical signal reflected by the rear surface of the diplexer may be converted into an electrical signal by the optical modem and utilized for verifying optical communication performance.

According to an example embodiment, the processor 120 may process the optical signal using at least one collimator or post-process the optical signal through an amplifier and/or an optical filter. Here, the operation of processing the optical signal through a collimator refers to a processing operation that aligns the optical signal parallel (e.g., optical collimation). Through this, the processor 120 may prevent the optical signal from diverging and adjust the beam characteristics to match the characteristics of the electronic device 100. Furthermore, the operation of post-processing the optical signal through a second amplifier (e.g., a low noise optical amplifier (LNOA)) and an optical filter (e.g., an optical bandpass filter (OBPF)) may include the operation of amplifying the optical signal of the desired wavelength band and reducing the noise figure through polarization mode dispersion (PMD) control via the amplifier structure and/or pump control method, and the operation of passing only a specific optical band while blocking the remaining wavelengths. Through this, the processor 120 may secure an SNR improvement effect by amplifying the optical signal and maintain the target output power and minimum noise.

For example, the processor 120 may process at least one optical signal amplified through the first amplifier using the first collimator (e.g., first collimator 261 in FIGS. 2A and 2B). The processor 120 may identify a designated optical signal separated using the diplexer from the at least one optical signal processed using the first collimator. The designated optical signal may be the optical signal corresponding to a laser for reception that is re-input to the optical modem for verification of optical communication performance.

For example, the processor 120 may process the designated optical signal, which is then transmitted back to the detector and optical modem via the diplexer and/or beam splitter, using a second collimator (e.g., second collimator 262 in FIGS. 2A and 2B). The processor 120 may post-process the designated optical signal processed using the second collimator through the second amplifier and the optical filter. The processor 120 may then convert the post-processed designated optical signal into a designated electrical signal using the optical modem and verify the optical communication performance.

According to an example embodiment, the processor 120 may verify optical communication performance using a loopback signal obtained through a loopback structure additionally implemented in the aforementioned example.

For example, the electronic device 100 may include a first switch positioned downstream of the optical modulator (e.g., downstream of the optical modulator and upstream of the first amplifier, or between the optical modulator and the first amplifier). For example, the electronic device 100 may include a second switch positioned downstream of the first amplifier (e.g., downstream of the first amplifier and upstream of the diplexer (or the first collimator), or between the first amplifier and the diplexer (or the first collimator)).

For example, the processor 120 controls the opening and closing of the first switch so that the first loopback signal, which is one of the at least one optical signal converted by the optical modulator, is directly delivered to the optical modem, or controls the opening and closing of the second switch so that the second loopback signal, which is one of the at least one optical signal amplified by the first amplifier, is delivered to the optical modem after being post-processed through the second amplifier and an optical filter.

For example, the processor 120 may use the optical modem to convert at least some of the first loopback signal and the second loopback signal into the designated electrical signal and verify the optical communication performance using the designated electrical signal.

For example, the first loopback signal may be attenuated through a first variable optical attenuator (e.g., VOA) (e.g., first variable optical attenuator 281 in FIGS. 2A and 2B), then transmitted to the optical modem after passing through the optical filter, and the second loopback signal may be attenuated through a second variable optical attenuator (e.g., second variable optical attenuator 282 shown in FIGS. 2A and 2B) before being transmitted to the optical modem via the second amplifier and the optical filter.

For example, the processor 120 may control the opening and closing of the first switch and second switch based on user control input. Alternatively, the processor 120 may further verify optical communication performance by controlling the opening and closing of the first switch and second switch when the optical signal passed through the diplexer indicates verified optical communication performance below a specified threshold.

For example, the wavelength difference between the first optical signal and the second optical signal may be less than or equal to a specified wavelength (e.g., 17 nm), and the frequency difference between the first optical signal and the second optical signal may be less than or equal to a specified frequency (e.g., 2 THz).

The aforementioned example embodiments may be implemented as artificial intelligence (AI) through the memory 110 and processor 120 of the electronic device 100. The processor 120 may be composed of one or more processors, in which the one or more processors may be general-purpose processors such as CPU, AP, or DSP (digital signal processor), graphics-dedicated processors such as GPU or VPU (vision processing unit), or AI-dedicated processors such as NPU. The one or more processors may be controlled to process input data according to predefined operational rules or an AI model stored in the memory 110. Alternatively, if the one or more processors are dedicated AI processors, these dedicated AI processors may be designed with a hardware architecture specialized for processing a specific AI model.

The predefined operational rules or AI model are characterized by being created through learning. Here, “created through learning” means that a basic AI model is trained using a learning algorithm and a large amount of training data, thereby creating predefined operational rules or an AI model configured to perform desired characteristics (or objectives). This learning may occur within the electronic device 100 itself where the AI according to this disclosure is performed, or it may occur via a separate server and/or system. Examples of learning algorithms include supervised learning, unsupervised learning, semi-supervised learning, or reinforcement learning, but are not limited to the aforementioned examples.

An AI model may be composed of multiple neural network layers. Each of these multiple neural network layers possesses multiple weight values and may perform neural network computations through operations involving the computational results of the previous layer and these multiple weight values. The multiple weight values held by the multiple neural network layers may be optimized based on the learning results of the AI model. For example, during the learning process, the multiple weight values may be updated to reduce or minimize the loss value or cost value acquired by the AI model. Artificial neural networks may include deep neural networks (DNNs), convolutional neural networks (CNNs), recurrent neural networks (RNNs), restricted Boltzmann machines (RBMs), deep belief networks (DBNs), bidirectional recurrent deep neural networks (BRDNNs), or deep Q-networks, but are not limited to the aforementioned examples.

According to an example embodiment, the electronic device 100 may perform at least one operation for verifying optical communication performance based on predefined rules or AI models stored in the memory 110.

FIG. 2A is a block diagram illustrating components of an electronic device performing an optical communication performance verification method according to an example embodiment.

FIG. 2B is a block diagram illustrating components of an electronic device performing an optical communication performance verification method according to an example embodiment.

FIG. 2C is a block diagram illustrating components of an electronic device performing an optical communication performance verification method according to an example embodiment.

FIG. 2A corresponds to an example embodiment of an electronic device including a plurality of laser generation devices that are distinct from one another, and FIG. 2B may correspond to an example embodiment of an electronic device 100 including a single integrated laser generation device. Furthermore, FIG. 2C may be a diagram illustrating the optical signal transmission path between components included in the electronic device 100.

According to an example embodiment, the electronic device (e.g., electronic device 100 of FIG. 1) includes a modem 210 (or, optical modem), an RF driver 220, at least one laser generation device (e.g., first laser diode 231 and second laser diode 232, or integrated laser diode 230), an optical modulator 240, an HPOA 251 (or first amplifier), an LNOA 252 (or, second amplifier), an OBPF 253 (or, optical filter), a detector 255 (or, photodetector), a first collimator 261, a second collimator 262, a diplexer 270, a telescope 275, a splitter 280 (or, beam splitter), and a sensor 285. For example, the electronic device may include a first variable optical attenuator 281, a second variable optical attenuator 282, a first switch 291, a second switch 292, a PAA (point ahead mirror) 293, a fast steering mirror (FSM) 294, a retro-reflector 295, or at least one combination thereof.

According to an example embodiment, the electronic device may control at least some of the depicted components via a processor (e.g., processor 120 of FIG. 1). For example, the processor may be implemented to include at least one of the depicted components (e.g., modem 210, RF driver 220, detector 255). Therefore, some of the operations described as being performed by the modem 210, RF driver 220, and detector 255 may be understood as operations of the processor.

According to an example embodiment, based on the drawings shown in FIGS. 2A and 2B, the path extending from left to right may be referred to as the transmission path, and the path extending from right to left may be referred to as the reception path. The electronic device may transmit a signal or laser generated using the modem 210 or at least one laser generation device through the path extending from left to right, and then radiate it into free space using the telescope 275. The electronic device may generate a laser using the at least one laser generation device, separate an optical signal corresponding to at least a portion of the generated laser via the diplexer 270, and then transmit it back to the modem 210 via the right-to-left path as the receiving path for processing, thereby verifying its own optical communication performance.

According to an example embodiment, the modem 210 may generate electrical signals or perform operations to convert optical signals into electrical signals.

According to an example embodiment, the RF driver 220 may amplify the electrical signal generated by the modem 210 and input it to the optical modulator 240.

Referring to FIG. 2A, according to an example embodiment, the first laser diode 231 may generate a first laser of a first wavelength band, and the second laser diode 232 may generate a second laser of a second wavelength band. In the example embodiment of FIG. 2A, a coupler 235 may be disposed downstream of the first laser diode 231 and the second laser diode 232. The electronic device may perform processing for the different lasers using the coupler 235.

Referring to FIG. 2B, according to an example embodiment, the integrated laser diode 230 may generate different lasers (e.g., a first laser and a second laser) corresponding to wavelengths included in the first wavelength band and the second wavelength band, respectively.

According to an example embodiment, the optical modulator 240 may convert an amplified electrical signal transmitted via the RF driver 220 and/or at least one laser transmitted from the at least one laser generation device into at least one optical signal.

For example, the optical modulator 240 may receive at least one laser input from the at least one laser generation device and receive an electrical signal input from the RF driver 220 for modulating the at least one laser. The optical modulator 240 may use the electrical signal to modulate (or amplify) the at least one laser.

According to an example embodiment, the HPOA 251 may amplify the at least one optical signal delivered from the optical modulator 240.

According to an example embodiment, the first collimator 261 (or transmitting end collimator) may process the at least one optical signal amplified by the HPOA 251.

According to an example embodiment, the PAA 293 may transmit the at least one optical signal processed by the first collimator 261 to the diplexer 270.

According to an example embodiment, the diplexer 270 may separate different optical signals based on the optical characteristics of the at least one optical signal. For example, the diplexer 270 may separate the at least one optical signal into a first optical signal and a second optical signal based on the wavelength and/or frequency of the at least one optical signal.

For example, the diplexer 270 may transmit the first optical signal to the telescope 275 via the FSM 294. The telescope 275 may radiate the transmitted first optical signal into free space.

For example, the diplexer 270 may transmit the second optical signal to the splitter 280. Alternatively, the electronic device may be implemented without including the splitter 280, in which case the diplexer 270 may transmit the second optical signal directly to the second collimator 262. The second optical signal delivered to the second collimator 262 may be converted into a designated electrical signal via the modem 210 and utilized for verifying optical communication performance.

According to an example embodiment, the splitter 280 (or SBS (spectral beam splitter)) may transmit a portion of the optical signal delivered by the diplexer 270 to the sensor 285 and/or the second collimator 262.

According to an example embodiment, the sensor 285 may acquire (or detect) at least a portion of the designated optical signal (e.g., the second optical signal) transmitted from the splitter 280.

According to an example embodiment, the second collimator 262 may process at least a portion of the designated optical signal (e.g., the second optical signal) reflected by the diplexer 270 and transmitted through the splitter 280.

According to an example embodiment, the LNOA 252 may amplify the designated optical signal processed by the second collimator 262.

According to an example embodiment, the OBPF 253 may perform filtering on the amplified designated optical signal.

According to an example embodiment, the detector 255 may detect (or identify) the designated optical signal post-processed by the LNOA 252 and the OBPF 253 and transmit it to the modem 210.

According to an example embodiment, the modem 210 may convert the designated optical signal transmitted via the detector 255 into a designated electrical signal and verify the optical communication performance of the electronic device based on the characteristics of the designated electrical signal.

Additionally or alternatively, the electronic device may further include at least two additional loopback structures.

According to an example embodiment, the electronic device may include a first switch 291 positioned downstream of the optical modulator 240 and a second switch 292 positioned downstream of the HPOA 251.

For example, the electronic device may control the opening and closing of the first switch 291 so that the first loopback signal, among at least one optical signal converted via the optical modulator 240, is delivered directly to the modem 210 without passing through the diplexer 270. Through this, the optical signal modulated by the optical modulator 240 may be transmitted to the modem 210 via the OBPF 253 and the detector 255. The modem 210 may use the first loopback signal to verify optical communication performance.

For example, the electronic device may control the opening and closing of the second switch 292 so that the second loopback signal, among at least one optical signal amplified by the HPOA 251, is delivered directly to the modem 210 without passing through the diplexer 270. Through this, the optical signal amplified by the HPOA 251 may be delivered to the modem 210 after being post-processed via the LNOA 252 and OBPF 253. The modem 210 may verify optical communication performance using the second loopback signal.

For example, the first loopback signal may be attenuated through the first VOA 281, then transmitted to the modem 210 via the OBPF 253, and the second loopback signal may be attenuated through the second VOA 282, then transmitted to the modem 210 via the LNOA 252 and OBPF 253.

Referring to FIG. 2C, the transmission path of the at least one optical signal transmitted from the at least one laser generation device through the first collimator 261 of the transmitting end is described. The components shown are some of the components included in the electronic device 100, and the remaining components may be omitted for convenience.

According to an example embodiment, the transmission path according to reference numeral 201 may be the first transmission path for the first laser (or, the first optical signal), and the transmission path according to reference numeral 202 may be the second transmission path for the second laser (or, the second optical signal).

For example, the electronic device 100 may convert at least one laser generated by the at least one laser generation device into an optical signal, amplify it, and then deliver it to the first collimator 261. The optical signal delivered to the first collimator 261 may include a first optical signal for emission into free space and a second optical signal for performance verification of the electronic device 100.

For example, the first optical signal and the second optical signal processed by the first collimator 261 may be delivered to the diplexer 270 via the PAA 293.

For example, the first optical signal among the optical signals delivered to the diplexer 270 may be delivered to the telescope 275 via the FSM 294, and the second optical signal may be delivered to the retro-reflector 295.

For instance, the first optical signal may be emitted into free space from the telescope 275 via a first mirror 298 and a second mirror 299. The first mirror 298 and second mirror 299 are exemplary configurations, and the electronic device 100 may include additional mirrors or may omit either the first mirror 298 or the second mirror 299.

For example, the second optical signal may be reflected by the retro-reflector 295 toward the rear surface of the diplexer 270, and then reflected again by the rear surface of the diplexer 270 to be incident onto the splitter 280. At least a portion of the second optical signal incident on the diplexer 270 may be detected by the sensor 285 or transmitted to the second collimator 262, which is one of the components of the receiving end.

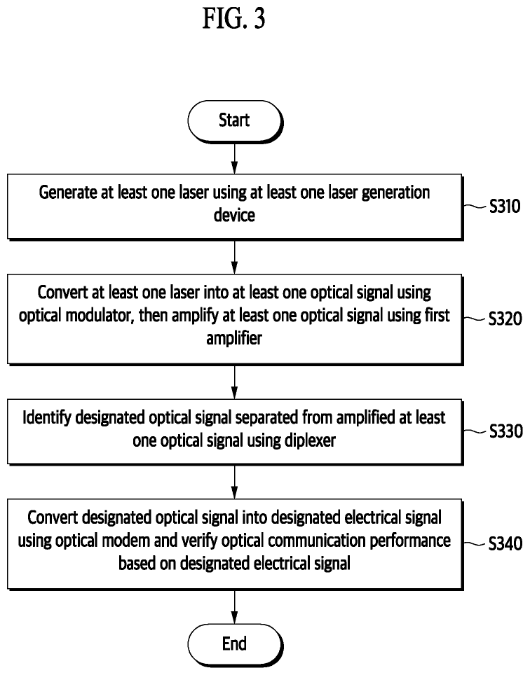

Hereinafter, a method by which the electronic device verifies optical communication performance will be described in detail in the description of FIGS. 3 to 5.

FIG. 3 is a flowchart illustrating a method for verifying optical communication performance by an electronic device according to an example embodiment.

According to an example embodiment, the electronic device 100 may perform the operations disclosed in FIG. 3. For example, at least some of the components included in the electronic device 100 (e.g., the memory 110 and/or processor 120 of FIG. 1) may be configured to perform the operations of FIG. 3.

In the following example embodiments, operations S310 to S340 may be performed sequentially, but they are not necessarily performed sequentially. For example, the order of each operation may be changed, and at least two operations may be performed in parallel. Furthermore, content corresponding to or duplicating that described in relation to FIG. 3 may be briefly described or omitted.

According to an example embodiment, the electronic device 100 may generate at least one laser using at least one laser generation device in operation S310.

For example, the at least one laser generation device may include a wavelength-tunable DBR or an ITLA.

For example, the electronic device 100 may generate a first laser and a second laser with different wavelength bands using the at least one laser generation device.

According to an example embodiment, the electronic device 100 may convert the at least one laser into at least one optical signal using an optical modulator, then amplify the at least one optical signal using a first amplifier in operation S320.

For example, the first amplifier may correspond to an HPOA.

According to an example embodiment, the electronic device 100 may identify a designated optical signal separated from the amplified at least one optical signal using a diplexer in operation S330.

For example, the diplexer may separate the at least one optical signal into a first optical signal and a second optical signal based on optical characteristics (e.g., wavelength or frequency) of the at least one optical signal including the first optical signal and the second optical signal. The electronic device 100 may identify the separated first optical signal and second optical signal.

According to an example embodiment, the electronic device 100 may convert the designated optical signal into a designated electrical signal using an optical modem and verify optical communication performance based on the designated electrical signal in operation S340.

For example, the electronic device 100 may self-verify its optical communication performance through signal-to-noise ratio (SNR), bit error rate (BER), modulation signal analysis (eye diagram), phase noise, and frequency response analysis of the designated electrical signal. For example, the electronic device 100 may monitor in real time the operational status (e.g., whether it is operating normally) of at least some of the components included in the electronic device 100, alignment status, and wavelength matching of optical devices through performance verification logic including the aforementioned algorithm.

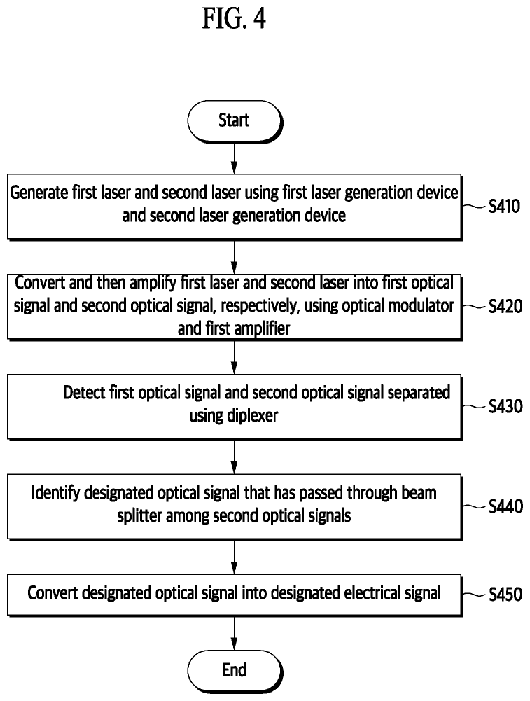

FIG. 4 is a flowchart illustrating a method for verifying optical communication performance by an electronic device according to an example embodiment.

According to an example embodiment, the electronic device 100 may perform the operations disclosed in FIG. 4. For example, at least some of the components included in the electronic device 100 (e.g., the memory 110 and/or processor 120 of FIG. 1) may be configured to perform the operations of FIG. 4.

In the following example embodiments, operations S410 to S450 may be performed sequentially, but they are not necessarily performed sequentially. For example, the order of each operation may be changed, and at least two operations may be performed in parallel. Furthermore, content corresponding to or duplicating that described in relation to FIG. 4 may be briefly described or omitted.

According to an example embodiment, the electronic device 100 may generate a first laser and a second laser using a first laser generation device and a second laser generation device in operation S410.

For example, the electronic device 100 may generate the first laser and the second laser using the first laser generation device that generates the first laser of a first wavelength band and the second laser generation device that generates the second laser of a second wavelength band different from the first wavelength band. In another example, the electronic device 100 may generate the first laser and the second laser with different wavelength bands using a single integrated laser generation device.

According to an example embodiment, the electronic device 100 may convert and then amplify the first laser and second laser into a first optical signal and a second optical signal, respectively, using an optical modulator and a first amplifier in operation S420.

According to an example embodiment, the electronic device 100 may detect the first optical signal and second optical signal separated using a diplexer in operation S430.

For example, the electronic device 100 may radiate the first optical signal, which is reflected after being separated by the diplexer, into free space using a telescope.

For example, the electronic device 100 may transmit the second optical signal, which is transmitted by the diplexer, to a beam splitter.

According to an example embodiment, the electronic device 100 may identify a designated optical signal that has passed through the beam splitter among the second optical signals in operation S440.

For example, the electronic device 100 may identify the designated optical signal, among the second optical signals, that passes through the diplexer, is reflected by a retro-reflector toward the rear surface of the diplexer, is reflected again by the rear surface of the diplexer to enter the beam splitter, and is transmitted through the beam splitter toward the optical modem. That is, the “designated optical signal” described in this disclosure may be at least a portion of the second optical signal. The electronic device 100 may also acquire at least a portion of the second optical signal using a sensor.

For example, the electronic device 100 may acquire at least a portion of the designated optical signal using a sensor.

According to an example embodiment, the electronic device 100 may convert the designated optical signal into a designated electrical signal in operation S450.

For example, the electronic device 100 may convert the designated optical signal (or the second optical signal) into the designated electrical signal using an optical modem, and then verify the optical communication performance of the electronic device based on at least a portion of the designated electrical signal or the designated optical signal (or the second optical signal).

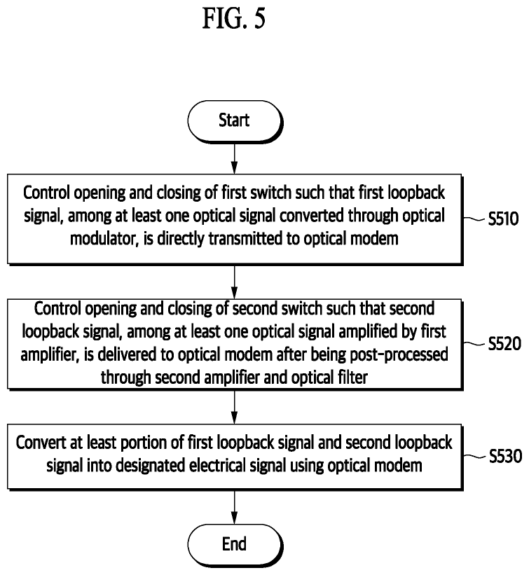

FIG. 5 is a flowchart illustrating a method for verifying optical communication performance by an electronic device according to an example embodiment.

According to an example embodiment, the electronic device 100 may perform the operations disclosed in FIG. 5. For example, at least some of the components included in the electronic device 100 (e.g., the memory 110 and/or processor 120 of FIG. 1) may be configured to perform the operations of FIG. 5.

In the following example embodiments, operations S510 to S530 may be performed sequentially, but they are not necessarily performed sequentially. For example, the order of each operation may be changed, and at least two operations may be performed in parallel. Furthermore, content corresponding to or duplicating that described in relation to FIG. 5 may be briefly described or omitted.

According to an example embodiment, the electronic device 100 may control the opening and closing of the first switch such that a first loopback signal, among the at least one optical signal converted through the optical modulator, is directly transmitted to the optical modem in operation S510.

According to an example embodiment, the electronic device 100 may control the opening and closing of the second switch such that a second loopback signal, among the at least one optical signal amplified by the first amplifier, is delivered to the optical modem after being post-processed through the second amplifier and the optical filter in operation S520.

According to an example embodiment, the electronic device 100 may convert at least a portion of the first loopback signal and the second loopback signal into the designated electrical signal using the optical modem in operation S530.

For example, the first loopback signal may be attenuated through the first variable optical attenuator, then transmitted to the optical modem via the optical filter, while the second loopback signal may be attenuated through the second variable optical attenuator, then transmitted to the optical modem via the second amplifier and optical filter.

According to example embodiments, it is possible to provide an electronic device capable of rapidly and accurately verifying its own optical communication performance within a single electronic device without additional equipment while minimizing the influence of external environments, an optical communication performance verification method thereof, and a non-transitory computer-readable storage medium having a computer program for performing the method recorded thereon.

According to example embodiments, an electronic device may independently inspect and monitor the status of optical communication components such as laser diodes, optical modulators, and optical receivers to ensure optimal optical communication performance. It also enables efficient verification of the accuracy and real-time status of the optical communication systems, and allows for pre-verification of optical communication performance and quality before the data link is established.

The effects of the present disclosure are not limited to the effects mentioned above, and other effects not mentioned will be clearly understood by those skilled in the art from the description herein.

Example embodiments of the present disclosure disclosed in this specification and drawings are merely specific examples provided to facilitate explanation of the technical content of the present disclosure and aid in its understanding, and are not intended to limit the scope of the present disclosure. That is, it is obvious to those skilled in the art to which the present disclosure pertains that other variations based on the technical concept of the present disclosure are feasible. Furthermore, each of the above example embodiments may be combined and operated together as needed. For example, all example embodiments of the present disclosure may be implemented by a system through the combination of their parts.

Moreover, methods according to the present disclosure, such as those for systems, may be implemented as program instructions executable by various computer means and recorded on computer-readable media.

Thus, various example embodiments of the present disclosure may be implemented as computer-readable code on a computer-readable recording medium from a particular perspective. A computer-readable recording medium is any data storage device capable of storing data that can be read by a computer system. Examples of computer-readable recording media include read-only memory (ROM), random access memory (RAM), compact disk-read only memory (CD-ROM), magnetic tapes, floppy disks, and optical data storage devices. Computer-readable recording media may also be distributed via networked computer systems, and thus computer-readable code is stored and executed in a distributed manner. Furthermore, functional programs, code, and code segments for achieving various example embodiments of the present disclosure can be readily interpreted by programmers skilled in the art to which the present disclosure pertains.

Furthermore, it will be understood that the devices and methods according to various example embodiments of the present disclosure may be implemented in the form of hardware, software, or a combination of hardware and software. Such software may be stored, for example, on volatile or non-volatile storage devices such as ROM or other storage devices, regardless of whether they are erasable or rewritable, or on memory such as RAM, memory chips, devices, or integrated circuits, or on storage media that can be recorded optically or magnetically and read by a machine (e.g., a computer) such as compact disks (CDs), DVD, magnetic disks, or magnetic tapes. Methods according to various example embodiments of the present disclosure may be implemented by a computer including a processor and memory, or by a vehicle including such memory or computer, and it will be understood that such memory is one example of a machine-readable storage medium suitable for storing a program or programs containing instructions for implementing example embodiments of the present disclosure.

Therefore, the present disclosure includes programs containing code for implementing the device or method described in the claims of this specification, and storage media that stores such programs and can be read by a machine (such as a computer). Furthermore, such programs may be electronically transmitted via any medium, such as a communication signal transmitted through a wired or wireless connection, and the present disclosure appropriately includes equivalents thereof.

The above description has referred to example embodiments of the present disclosure. However, example embodiments of the present disclosure disclosed in this specification and the drawings are merely specific examples provided to facilitate an easy explanation of the technical content of the present disclosure and to aid in understanding the present disclosure, and are not intended to limit the scope of the present disclosure. Furthermore, the example embodiments described above according to the present disclosure are merely illustrative. Those skilled in the art will understand that various modifications and equivalent example embodiments are possible based on them. Therefore, the true technical scope of protection of the present disclosure should be determined by the following claims.

What is claimed is:

1. An optical communication performance verification method performed by an electronic device, the optical communication performance verification method comprising:
generating at least one laser using at least one laser generation device;
converting the at least one laser into at least one optical signal using an optical modulator, and amplifying the at least one optical signal using a first amplifier;
identifying a designated optical signal separated using a diplexer from the amplified at least one optical signal; and
converting the designated optical signal into a designated electrical signal using an optical modem and verifying optical communication performance of the electronic device based on the designated electrical signal,
wherein the optical communication performance verification method further comprising:
identifying the designated optical signal separated using the diplexer from the at least one optical signal processed using a first collimator;
post-processing the designated optical signal processed through a second collimator via a second amplifier and an optical filter; and
converting the post-processed designated optical signal into the designated electrical signal using the optical modem.

2. The optical communication performance verification method of claim 1, wherein the at least one laser generation device comprises a wavelength-tunable DBR (Distributed Bragg Reflector) or ITLA (Integrable Tunable Laser Assembly), and
the optical communication performance verification method further comprises:
generating a first laser and a second laser having mutually different wavelength bands using the at least one laser generation device.

3. The optical communication performance verification method of claim 1, wherein the at least one laser generation device comprises:
a first laser generation device generating a first laser of a first wavelength band; and
a second laser generation device generating a second laser of a second wavelength band different from the first wavelength band, and
the optical communication performance verification method further comprises:
generating the first laser and the second laser;
converting the first laser and the second laser into a first optical signal and a second optical signal, respectively, using the optical modulator, and amplifying the first optical signal and the second optical signal using the first amplifier; and
identifying the first optical signal and second optical signal separated using the diplexer.

4. The optical communication performance verification method of claim 3, wherein the diplexer is configured to separate the first optical signal and the second optical signal based on optical characteristics comprising wavelengths or frequencies of the first optical signal and the second optical signal.

5. The optical communication performance verification method of claim 4, further comprising:
radiating the first optical signal reflected by the diplexer into free space using a telescope; and
converting the second optical signal transmitted by the diplexer into the designated electrical signal using the optical modem and verifying the optical communication performance of the electronic device based on the designated electrical signal.

6. The optical communication performance verification method of claim 5, wherein the second optical signal passes through the diplexer, is reflected by a retro-reflector toward a rear surface of the diplexer, and is reflected again by the rear surface of the diplexer to enter a beam splitter so that at least a portion of the second optical signal is transmitted from the beam splitter to a sensor or the second collimator, and
the optical communication performance verification method further comprises:
acquiring at least a portion of the second optical signal using the sensor; and
converting the second optical signal into the designated electrical signal using the optical modem, and verifying the optical communication performance of the electronic device based on the designated electrical signal or the at least a portion of the second optical signal.

7. The optical communication performance verification method of claim 6, wherein the diplexer comprises:
a first coating layer configured to transmit an optical signal of a designated wavelength band among the plurality of wavelength bands toward the retro-reflector and to reflect an optical signal outside the designated wavelength band toward the telescope; and
a second coating layer configured to reflect an optical signal of the designated wavelength band among the plurality of wavelength bands toward the optical modem.

8. The optical communication performance verification method of claim 1, further comprising:
controlling opening and closing of a first switch so that a first loopback signal among the at least one optical signal converted through the optical modulator is directly transmitted to the optical modem, or controlling opening and closing of a second switch so that a second loopback signal among the at least one optical signal amplified by the first amplifier is delivered to the optical modem after being post-processed through the second amplifier and the optical filter; and
converting at least a portion of the first loopback signal and the second loopback signal into the designated electrical signal using the optical modem,
wherein the first switch is positioned downstream of the optical modulator, and the second switch is positioned downstream of the first amplifier.

9. The optical communication performance verification method of claim 8, wherein the first loopback signal is attenuated through a first variable optical attenuator and transmitted to the optical modem via the optical filter, and
the second loopback signal is attenuated through a second variable optical attenuator and transmitted to the optical modem via the second amplifier and the optical filter.

10. A non-transitory computer-readable recording medium having a program for performing an optical communication performance verification method on a computer, the optical communication performance verification method comprising:
generating at least one laser using at least one laser generation device;
converting the at least one laser into at least one optical signal using an optical modulator, and amplifying the at least one optical signal using a first amplifier;
identifying a designated optical signal separated using a diplexer from the amplified at least one optical signal; and
converting the designated optical signal into a designated electrical signal using an optical modem and verifying the optical communication performance of an electronic device performing optical communication based on the designated electrical signal,
wherein the optical communication performance verification method further comprising:
identifying the designated optical signal separated using the diplexer from the at least one optical signal processed using a first collimator;
post-processing the designated optical signal processed through a second collimator via a second amplifier and an optical filter; and
converting the post-processed designated optical signal into the designated electrical signal using the optical modem.

11. An electronic device comprising:
a memory in which at least one instruction is stored; and
a processor operatively coupled to the memory,
wherein when executed by the processor, the at least one instruction allows the electronic device to:
generate at least one laser using at least one laser generation device;
convert the at least one laser into at least one optical signal using an optical modulator, and amplify the at least one optical signal using a first amplifier;
identify a designated optical signal separated using a diplexer from the amplified at least one optical signal; and
convert the designated optical signal into a designated electrical signal using an optical modem and verify optical communication performance of the electronic device based on the designated electrical signal,
wherein when executed by the processor, the at least one instruction further allows the electronic device to:
identify the designated optical signal separated using the diplexer from the at least one optical signal processed using a first collimator;
post-process the designated optical signal processed through a second collimator via a second amplifier and an optical filter; and
convert the post-processed designated optical signal into the designated electrical signal using the optical modem.
